(19) United States
(12) Patent Application Publication
(10) Pub. No.: US 2003/0163447 A1
(43) Pub. Date: Aug. 28, 2003

(54) Method and tool for assignment of item number by mapping of classification and generation of a decision tree

(76) Inventor: Monika Sandman, Cupertino, CA (US)

Correspondence Address: JOSEPH BACH, 17460 LAKEVIEW DRIVE, MORGAN HILL, CA, 95037, US

(21) Appl. No.: 10/085,781

(22) Filed: Feb. 28, 2002

(51) Int. Cl. G06F 7/00

(52) U.S. Cl. 707/1

(57) ABSTRACT

A method and tool for simplifying the Customs Classification process (e.g., assignment of HTSUS numbers to components and products). Using information about the importer's business, selected item numbers from the HTSUS are mapped onto a secondary classification set. Then, a decision tree is constructed for the secondary classification. A user interface is constructed which contains simplified questions to enable a user to “walk through” the decision tree and arrive at an appropriate classification.

### BACKGROUND OF THE INVENTION

1. Field of the Invention

The present invention relates to a method and tool for assigning an item number by mapping of the classification and generating a decision tree. The invention is particularly useful for handling Governmental classification, such as, for example, the assignment of classification numbers in the process of Import/Export of products.

2. Description of the Prior Art

As is well known, many business transactions are controlled by various Governmental rules and regulations. In many cases, the appropriate applicable rule or regulation depends on a proper characterization of the transaction or item at issue. In other circumstances, the appropriate characterization of the transaction or item helps in identifying certain actions that need to be taken to support the transaction. In one example, well known to patent practitioners, a patent application is assigned a classification number. The classification number is useful, for example, in identifying the appropriate area of the art for a prior art search. To accomplish the appropriate classification, the patent office publishes a Manual of Classification that is structured to mimic the Art Units and the cataloging of the art at the patent office.

Another useful example relates to import and export customs and controls. For example, when one wishes to import a particular product into the United States, one must assign an appropriate tariff classification using the Harmonized Tariff Schedule of the United States (HTSUS). The tariff number is used, among others, to determine the appropriate custom duties applicable. Therefore, assigning the proper tariff number to an imported item is highly important to both the Government and the importer.

However, the HTSUS is a voluminous catalogue of tariff numbers that is structured according to internal methodology of the World Customs Organization and US Customs. It is generally arranged in Sections, Chapters, Heading, Subheading, and Statistical Suffix numbers, which together comprise a 5″ thick volume. Consequently, appropriate assignment of an item number requires expertise in working with the HTSUS. Therefore, importers resort to the expertise of specialized customs agents or brokers. Still, while the customs brokers have a working knowledge of the HTSUS, in many cases they lack appropriate knowledge of the items to be imported and/or the general objective of the importer's business in order to select the proper item classification. Consequently, in addition to carrying the expense of hiring a customs broker, the importer also has to carry the burden of educating the broker about the item and/or business in order to arrive at the appropriate HTSUS classification.

For example, assuming the importer wishes to import a power supply. To begin with, there are many different power supplies that vary with size, operation, and character. So, the broker must have direct communication with someone within the importer company in order to learn about the particular power supply to be imported. In addition to that, many items are classified differently in the HTSUS depending on their end use. For example, some items that are used for telecommunication are clear of duty. So, it is possible that duties may be due on the power supply if it is imported for one purpose, but are not applicable if the power supply is imported for other uses, say, for a telecommunication system. Therefore, as noted above, the customs broker needs to learn of the importer's business in order to select appropriate classification of the imported item, which can place an enormous burden for companies that import hundreds or thousands of items.

In order to assist in the task of import and export classification, attempts have been made at creating automation tools, which are available as standard products on the commercial market. However, these commercial tools merely computerize the contents of the whole HTSUS. Such tools are difficult and costly to develop. Additionally, these tools require an end-user possessing regulatory classification expertise, thereby precluding successful use by a person who is not a customs practitioner. Still, while these tools may assist the brokers in handling the HTSUS side of the issue, the broker still needs to have support from the importer in order to fully understand the character of the items to be imported and the business environment and objectives.

Further information about the state of the art can be found at, for example, www.vastera.com; www.openharbor.com; and www.clearcross.com.

The problem of developing a tool to address multinational import/export classification needs is even more acute. From the user perspective, current tools do not provide for idiosyncrasies generated by different countries' customs rulings on specific commodities. In this respect, the HTS refers to the Harmonized Tariff System which is worldwide; however, different countries may implement their own localized system. For example, the U.S. system is called HTSUS, while the European Union system is called TARIC. To simplify, the examples provided herein will relate to the HTSUS, but it should be understood that the examples are equally applicable to any other country specific HTS worldwide.

Furthermore, there is a need for a tool that will take into account regulations promulgated by more than one governmental agency. Thus, for example, it is desirable to have a tool that, in addition to providing the proper classification, also flags other issues relating to the imported product, such as, for example, relevant regulation by the FDA, EPA, etc.

Accordingly, there's a need in the industry for a method and tool to simplify the process of classification.

### SUMMARY OF THE INVENTION

In order to alleviate the problems in the prior art, as detailed above, the present invention provides a methodology for designing automation tools to assist in classification of items.

In a general aspect of the invention, a classification index which was created under one set of characterization rules (e.g., Governmental body) is mapped onto a new field using a second set of characterization rules that correspond to the user's needs. A decision tree is then constructed using the items mapped onto the new field. A user interface is then constructed to walk the user through the decision tree in order to arrive at the appropriate classification.

In another aspect, the invention relates to the design of a user interface. The user interface is correlated to the newly mapped items index, rather than to the original government index. Through this interface, end-users are not required to have knowledge of the original characterization rules, but may use the system with knowledge of only the characteristics of the item to be classified.

In one example, the methodology is used to develop tools to streamline the import/export process of assigning HTSUS (Harmonized Tariff Schedule of the United States) and/or ECCN (Export Control Commodity Number) classifications to components and products. Using knowledge of the importer's business, selected items in the HTSUS are mapped onto an importer specific field. A decision tree is then constructed for the newly mapped items. Using the decision tree requires only knowledge of the importer's business, and doesn't require any knowledge of the HTSUS. Consequently, according to this example, users need not be Customs Classification Specialists and instead can rely on their knowledge of the importer's business to perform the classification.

A tool designed with this methodology may be tailored to a specific industry or business environment (for example a large corporation in the high tech field) and, therefore, may incorporate an algorithm that narrows the universe of possible items considered for classification.

Restricting the tool to a narrower universe provides an opportunity for an additional innovation which consists of the design of a user interface using “decision trees” in such a way that the operator is led, step by step, to provide information about the relevant characteristics of the item to be classified. When necessary, the tool also provides guidance regarding any additional information needed to complete the classification process. This minimizes users' uncertainty by clarifying boundaries and focusing the users in the right direction, thereby streamlining the classification process itself.

A tool designed applying these methodologies avoids the need for high-cost Customs and Export Control classification professionals by guiding regular employees through the process of assigning classification numbers to components and products. Employees involved in the process will usually belong to the Business Units or Product Teams, rather than to the corporate level, therefore possessing a better technical insight into the actual nature and functionality of the item considered. This assumed insight is leveraged by this invention to allow the creation of a tool which has as narrow a focus as possible, is easier to develop and rather straightforward to use.

Tools designed with these methodologies are naturally scaleable and with minimum effort can be made to include support for other countries' HTS (Harmonized Tariff System) nomenclatures.

This integrated approach is particularly valuable for multinational corporations and teams, who otherwise, would have to contend with various incompatible tools or worse yet, may not find in the market any automation tool to support their international classification needs.

According to another feature of the invention, as the item to be imported is classified, other relevant regulations are checked and appropriate message and/or action is provided to the user.

### BRIEF DESCRIPTION OF THE DRAWINGS

FIG. 1 depicts a block diagram illustrating an embodiment of the invention.

FIG. 2 depicts a decision tree according to an embodiment of the invention.

FIG. 3 depicts a process flow according to an embodiment of the invention.

FIGS. 4a and 4b depict a user interface according to an embodiment of the invention.

### DETAILED DESCRIPTION AND EXAMPLES

In its general aspect, the invention provides a methodology and a tool for simplifying classification when the original classification requires both an intimate knowledge of the workings of the classification system and the characteristics of the item to be classified. For a better understanding of various features and aspects of the invention, it will be described with respect to illustrative embodiments relating to export and import transactions. However, it should be understood that the examples by no means limit the scope of the invention or its applicability to other fields, but are rather provided to assist in understanding the various features of the invention.

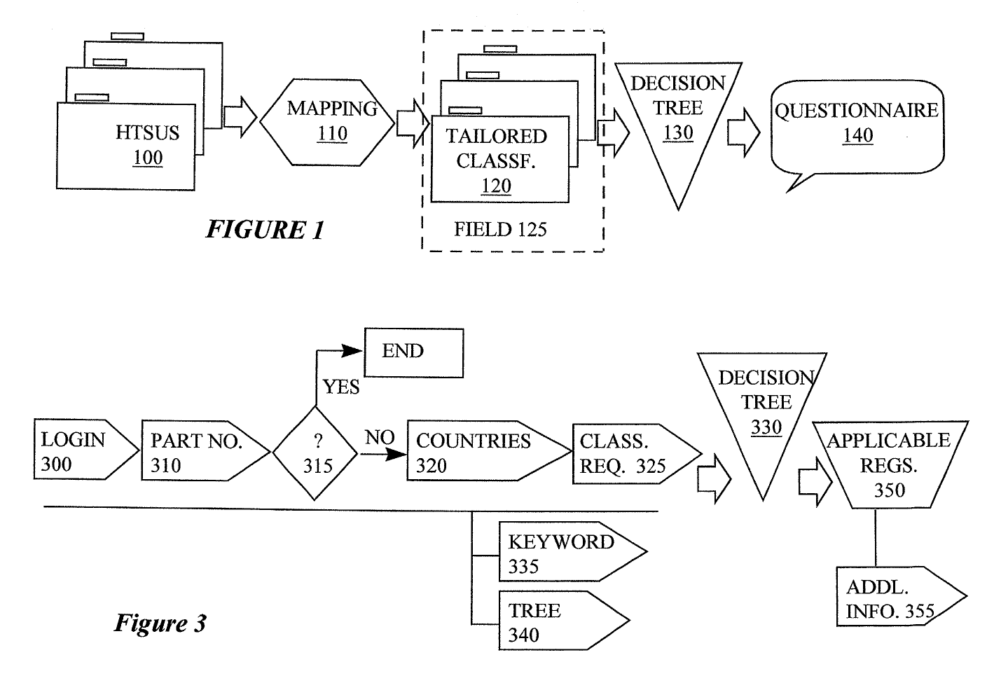

Referring to FIG. 1, the HTSUS 100 is compiled and organized by the US Government according to import rules and regulations and using internal methodology. The HTSUS is organized by Sections, Chapters, Heading, Subheading, and Statistical Suffix numbers. These are incorporated into the tariff number as follows: the first two digits of the item number identify the chapter number; the chapter together with the next two digits identify the Heading number, the heading together with the next two digits identify the Subheading number. These six digits are in principle harmonized worldwide. Each country adds 0-6 additional digits to identify a tariff number, where in the U.S. four digits are used (the first two additional digits are considered also a subheading, while the last two digits are called the statistical suffix). So, for example, a U.S. classification number 8471.49.5080 for CD or DVD drive inside a complete computer system indicates that the classification is in Chapter 84, Heading 8471, Subheading 8471.49, and tariff number 8471.49.5080.

As can be understood from the above, in order to classify an item, one must have a working knowledge of the HTSUS so as to navigate the Sections, Chapters, Headings and Subheadings, to arrive at the appropriate tariff number. Accordingly, a service industry employs customs brokers who specialize in navigating the HTSUS. However, to arrive at an appropriate classification, additional knowledge of the characteristics of the item and the business of the importer are necessary. Without that knowledge, an agent may spend enormous amount of time navigating the HTSUS, only to find out that the wrong path down the Sections, Chapters, Headings etc., was taken.

Additionally, as noted above, the classifier often has to have technical knowledge of the imported item and of the importer's business. To use the above example, the classifier needs to know whether the DVD player is for a home theater or for a computer system and, if for a computer system, whether it is imported independently or integrally to the computer system.

Moreover, according to the laws of the U.S., the ultimate responsibility for the proper classification of an imported item lies with the importer. To comply with the law, many large importers have, therefore, established their own import regulation departments, dedicated to classifying items imported by the company. Still, the import division is generally at the corporate level and employs personnel that specializes in HTSUS, but may not necessarily be knowledgeable in the field of the items imported, especially when the imported items are in the high tech field.

The present invention provides a method and tool for easy classification of imported items, which does not require any knowledge of the HTSUS by the end user. Consequently, no specialized personnel is necessary for the classification. Rather, the classification can be made by personnel from the technology division who better understand the technology involved.

According to a feature of the invention, an understanding of the importer business is utilized to generate a mapping 110 so as to transfer selected tariff numbers from the HTSUS into a new tailored classification 120 residing in a specific field 125. The field 125 may be importer specific, business specific, art specific, etc. That is, the field 125 may be narrowed to encompass only transactions known to be executed by the importer. On the other hand, the field 125 may be expanded to encompass transactions known to be executed by a particular industry segment, e.g., computer makers. The idea here is that unlike the HTSUS whose field is every transaction conceivable, the field 125 is tailored to a specific segment of transactions. Therefore, the tariff numbers mapped onto classification 120 are, in most cases, a subset of the tariff numbers in the HTSUS.

Moreover, while the HTSUS classification is organized according to Governmental rules and regulations, the classification 120 is organized according to specific item and/or business characteristics. To illustrate, in the HTSUS a local area network, LAN, is termed a Controller or Adapter Unit. Accordingly, one needs a working knowledge of the HTSUS in order to know the HTSUS's term for LAN. Then, while navigating the HTSUS one may find a tariff number for LAN under the Chapter that covers Computers. On the other hand, if the LAN is used for telephony, the proper tariff number can actually be found under the Chapter that covers Telecommunication. To find that classification one needs to look under Electrical Apparatus for line telephony. Furthermore, in this case there is no reference to ‘controllers or adapter units’; the user is expected to know that customs authorities have interpreted that LAN equipment that hooks into telephone lines is to be classified in this area.

To avoid such potential misclassification under the HTSUS system, the new tailored classification 120 is organized according to the specific requirement of the business at hand. So, for example, if the business is a computer maker, as in the above example, only the tariff number from the Computers Chapter needs to be mapped onto classification 120. On the other hand, if the business is in the telecommunication field, only the tariff number under the Telecommunication Chapter needs to be mapped onto classification 120. Also, if when preparing the mapping 110 it is learned that the business participates in both computers and telecommunication fields, an appropriate action can be taken to avoid confusion. The appropriate action may be in the form of a flag, a change in classification, or an appropriate branch in decision tree 130.

That is, according to a further feature of the invention, once the mapping is performed, a decision tree 130 is constructed to assist in navigation of the new tailored classification 120. A particular feature of the invention is that the decision tree 130 is constructed so that each branch point is selected with regards to the characteristics of the item and/or business. Consequently, proper navigation of the tailored classification 120 requires no knowledge of the import rules or HTSUS classification methodology. Rather, all that is required is knowledge of the business and the items to be imported. This feature enables the importer itself to arrive at a proper classification without resort to an import professional.

To illustrate, lasers can be found in many items of vastly different characteristics. For example, lasers can be found in industrial fabrication machinery and in toys. Therefore, if the item to be imported is a laser, in the prior art one needs to navigate the volumes of entries in the HTSUS that could directly or obliquely refer to lasers to determine the appropriate tariff number. However, under a feature of the invention, knowledge of the business is utilized to map the items and construct the decision tree. So if, for example, the importer is in the toys business, only the laser items relating to toys need to be mapped onto the new classification 120. Similarly, since it is known that only lasers relating to toys have been mapped, the decision tree is constructed only according to issues relating to lasers for toys, for example, type of optical elements present, exclusion of gas lasers, etc.

In accordance with the features of the invention, once a decision tree 130 is constructed, appropriate user interface is constructed in the form of questionnaire 140. Again, since the decision tree is constructed to correlate to the business environment, rather than to the import regulations, the questions presented in questionnaire 140 relate to the business and can, therefore, be answered by the importer without resort to import professionals. Using the above laser toy example, the questionnaire would track the decision tree to arrive at the appropriate tariff number by asking questions such as “does the laser contain erbium doped fiber?” “Are there any optical elements in the laser assembly?” etc. As can be understood, these are questions that can be easily answered by the importer, but may be somewhat difficult for an import professional not familiar with laser technology. Of course, the questionnaire 140 is not limited to the form of questions, but may also include other forms, such as, for example, a selection grid. For example, rather then asking whether the laser contains optical elements, the questionnaire can simply ask the user to select the type of optical element present (lenses, mirrors, prisms, filters or none) from a list provided.

### EXAMPLE 1

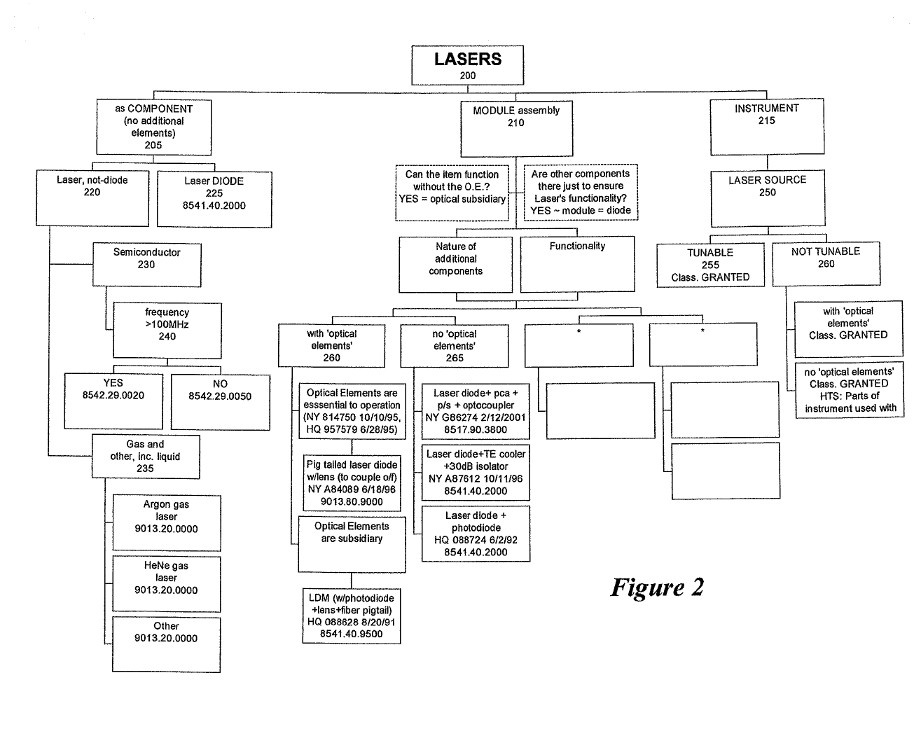

FIG. 2 depicts a decision tree for an example where the importer imports, among other, various lasers and laser components. In addition to demonstrating the mapping and decision tree features of the invention, Example 1 also demonstrates the “building blocks” feature of the invention. That is, according to a feature of the invention, the new classification 120 is structured in a building blocks manner, so that it can be easily expanded should the business of the importer expand. So, as shown in Example 1, the laser classification and decision tree is structured as one block. Thus, it can serve an importer who imports only lasers, it can serve as a block for an importer who imports various items including lasers, or it can be supplemented later on with new blocks should the laser importer decide to import other products.

As can be understood, lasers come in many shapes, forms and for many different applications. Using knowledge of the importer's business, the appropriate mapping 110 can be structured so as to map only laser classification corresponding to the particular importer. Once these item classifications have been mapped onto new classification 120, a decision tree can be constructed, as exemplified in FIG. 2. In this example, once the user selects the laser decision tree, 200, the user next needs to select whether the product to classify will be imported as a component, 205, a module assembly, 210, or an instrument, 215. Assuming the user selects component, 205, the user is then next prompted to select whether the imported item is a diode or non-diode laser, 225 and 220, respectively. If the user selected non-diode, 220, the user is then prompted to select whether the laser is a semiconductor or not, 230 and 235 respectively. Assuming that the user selects semiconductor, 230, having frequency higher than 100 MHz (step 240), then the classification number is 8542.29.0020.

As can be seen from this example, the user need not have any knowledge of import regulation and/or the HTSUS. Rather, the user need only have technical knowledge of the item to be imported. Consequently, using this example of the invention, the item classification can be made by technical personnel, and no dedicated import personnel need to be involved.

The following demonstrates the tremendous benefits of using the invention, as illustrated by the embodiment of FIG. 2. Assuming an importer seeks to classify a diode laser. Using the prior art, the person would naturally search the HTSUS tariff index. Under the entry “laser,” one can find the result: “laser, other than diodes.” This may lead the person to suspect that there is no entry for laser diode in the HTSUS. This is so since the index contains no entry for “laser diode.” Thus, a person unfamiliar with the HTSUS may have no clue how to proceed.

If one looks up the entry for “diodes” instead, one would be led to heading 8541: “Diodes, transistors and similar semiconductor devices; photosensitive semiconductor devices, including photovoltaic cells whether or not assembled in modules or made up into panels, light-emitting diodes; mounted piezoelectric crystals; parts thereof.” So, one may decide to follow that path. However, next one has to select the Subheading. From engineering perspective, one may be led to 8541.10: “Diodes, other than photosensitive,” since one may consider laser diode as not photosensitive. This would lead to erroneous classification, since from the customs regulatory perspective, laser diodes are considered as photosensitive devices. So, the correct path to select would be Subheading 8541.40: “Photosensitive semiconductor devices, including photovoltaic cells whether or not assembled in modules or made up into panels; light emitting diodes.” Under this Subheading one may find 8541.40.2000: “Light emitting diodes (LED's).” Of course, an engineer would conclude that the wrong path was selected, since from engineering perspective an “LED” is not a “laser diode.” However, from the tariff perspective this is actually the correct classification, which, of course, would be very misleading for persons not familiar with the HTSUS classification process.

To contrast that, according to the embodiment illustrated in FIG. 2, one enters the decision tree for lasers, 200, and is then asked whether the laser is a component, 205, a module assembly, 210, or an instrument 215. Since the item in the example is a laser diode, one can easily select the ‘component” 205 entry. In response, one would be prompted to select between “laser, non diode” (220) or “Laser diode” (225). Thus, an engineer can easily obtain the proper classification without knowledge of the HTSUS and no need to search the tariff index. Rather, the engineer is presented with selections which are provided in “engineering” terms easily recognized by engineers, rather than by customs terms which may be recognized only by customs professionals.

### EXAMPLE 2

FIG. 3 illustrates a flow chart for a tool implementing an embodiment of the present invention. The tool is implemented as a computer program with a user interface allowing proper assignment of import tariff number. The user is first prompted to login to the system, step 300. In step 310 the user is prompted to provide the part number of the part to be classified. The part number can be an internal number to the importer, a UPC bar code, etc., and may be entered by keying in the number, using a bar code reader, etc. According to a specific feature of the invention, the system then checks to see if that part number has already been assigned a classification number (step 315). If so, the user is informed that a classification is assigned to this part already, and the process as to this particular part ends.

In step 320 the user is prompted to enter the countries of interest. This will allow assigning HTS classifications for the additional countries selected. Furthermore, in some cases different regulations from other government agencies may apply depending on the country of origin and country of import, hence the user needs to input the country of origin and the country of import. In this example more than one country of origin and country of import may be entered, for concurrent classification to more than one country. The user then may begin the classification process at step 325. In classification request 325 the user is prompted to answer questions that are tailored to walk the user through decision tree 330, which operates in the background. That is, the user need not even know that a decision tree exists. The user simply answers the questions when prompted and, when completed, the classification is provided.

A feature of the embodiment depicted in FIG. 3 is that at any given time, the user may enter a keyword area 335, wherein the user is provided definitions to various items, so as to assist the user in progressing through the decision tree 330 by clarifying the meaning of terms.

A further feature of the embodiment of FIG. 3 is that the user may be given direct access to various locations on the decision tree by using keywords. To illustrate using the example of FIG. 2, if the user types in the keyword “laser, not diode,” the user will be directed to the decision tree for lasers, 200, with the indicated location 220. The user may then decide whether to proceed using the decision tree directly, or return to the classification request 325. Alternatively, after typing the keyword the system progresses to the appropriate question in the classification request 325, which correspond to the location on the decision tree 330.

Another feature of the embodiment of FIG. 3 is that when a classification is selected, the system searches for other applicable regulations for that particular item (Step 350). The additional regulation need not necessarily be for customs purposes only. For example, other regulatory law, such as FDA, FCC, EPA, etc., can be scanned for particular regulations relating to the item selected. Similarly, information that may be considered important for the import broker can be noted. For example, the user can be prompted that a “hazardous material” legend must be applied to the packaging, etc. Of course, this feature is made possible since according to embodiments of the invention business knowledge is used to map the items from the HTSUS, and that same knowledge can be used to include in the system appropriate regulatory law from other branches of government.

A further feature of the embodiment of FIG. 3 is that when the classification is selected, the user is able to input additional information to the system (Step 355). Such information can be, for example, specific handling or packaging instructions etc. This information can be included with the documentation for the item.

### EXAMPLE 3

As noted with respect to Example 2, various rules and regulations can be incorporated into the system, in addition to the mapping of the tariff numbers. This is important even just from the correct classification aspect of the invention. To illustrate, assume one wishes to classify a signal generator. Following the tariff index and the HTSUS, one may be led to the classification 8543.20.0000: “Electrical Machines and apparatus, having individual functions not specified or included elsewhere in this chapter; parts thereof: Signal generators.”

However, per U.S. Customs rulings, the correct classification for signal generators in the U.S. is 9030.40.0000; 9030.82.0000 or 9030.89.0000, depending on whether the signal generator is designed for use in telecommunication testing, semiconductor testing or other type of testing, respectively. Of course, an engineer having no knowledge or access to U.S. Customs rulings, will have no way of obtaining the correct classification. Using the methods of the present invention, on the other hand, makes knowledge of the ruling by the user unnecessary. Instead, the ruling is used in the mapping and the decision tree creation steps and can be made transparent to the user.

To illustrate, if the importer is known to be only in the telecommunication business, then in the mapping stage there is no reason to map any other classifications for signal generator, but the one relating to telecommunication, i.e., 9030.40.0000. Thus, when making the decision tree, when one selects signal generator, only the classification for the telecommunication use is provided, and is correct for that particular user. On the other hand, if it is not known beforehand that the importer is importing signal generators only for use in a particular field, in the mapping stage all three classifications are mapped into the new field 125. However, in constructing the decision tree 130, account is made of the Customs ruling, by including a decision relating to the use of the signal generator. Thus, the user may be prompted to select:

“Will the signal generator be used for:

telecommunication testing

semiconductor testing

other type of testing

The user need not know the purpose of this selection or the ruling that led to it. The user simply makes the selection according to the signal generator in question, and the system internally selects the appropriate path to the appropriate classification.

### EXAMPLE 4

As noted with respect to Example 2, the system may also account for regulations of different countries. Again, this can be provided in the form of “modules” or “blocks,” so that only the countries relevant to the particular importer are considered. This feature is important since classifications are not readily transferable between countries. That is, while the use of Chapters, Headings and Subheadings numbers is international (first six digits), the actual classification may vary across countries.

To illustrate, assume one wishes to import a “License to Use” certificate for software into the U.S., Europe, and Asia Pacific. Attempting to classify the license using the HTSUS, one may select the classification 4907.00.0000: “document of title.” Since the Chapter, Heading, etc. arrangement is international, one may assume that the same classification should be applied to Europe and Asia Pacific. However, in fact, in Europe the license would be classified as 4901.10: “publication,” while in some Asia Pacific countries the license would be classified as 4911.99: “other printed matter.”

Using the method of the invention, on the other hand, the user need not worry about the various interpretations given by different countries. Rather, in preparing the “countries” module, the appropriate selections are taken into account. Thus, when the user selects the relevant countries, as in step 320 of FIG. 3, the system would automatically select the appropriate classification for each selected country.

### EXAMPLE 5

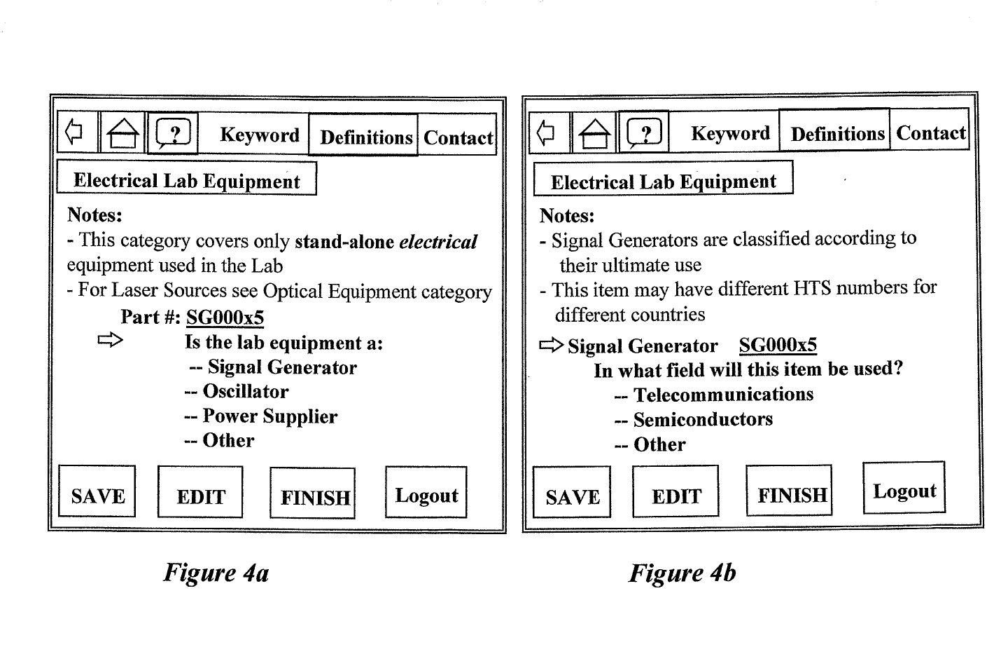

FIGS. 4a and 4b illustrate a user interface according to an embodiment of the invention. In this example, the user interface is implemented in a manner very similar to web site design, and may utilized HTML, XTML, Java, and other web-styled programming language and tools. For example, use can be made of hypertext to enable navigation and/or response to the various questionnaire inquiries. As illustrated in FIG. 4a, at the top of the screen various actionable icons are provided, in this example, from left to right, “back page” “home” “help” “keyword search” “Definitions” and “contact.” The “back page” “home” and “help” icons are conventional to web page designs. The “Keyword” icon takes the user to a keyword search index. The index contains an alphabetized list of keywords, each with an explanation of what the keyword means within the context of the importer's business. The “Definitions” icon takes the user to a definition dictionary which contains explanations of terminology and general guidance on concepts used throughout the application. The “contact” button can be programmed to provide contact information of the company's administrator, contact information of the program provider, or both.

Optionally, the keyword index also contains guidance to the choices that need to be made in classifying objects. This guidance is provided in order to guide an engineering minded user, who may not appreciate the regulatory philosophy. Using the above laser example, the explanation under “laser diode” may read: “laser diodes constitute the light sources in high speed fiber optic communication systems due to their characteristics of emitting coherent light beams. They are photosensitive semiconductor devices in which the action of visible rays, infra-red rays, or ultraviolet rays causes variations in resistivity or generates an electromotive force by the internal photoelectric effect. For customs classification purposes they are considered to be conceptually similar to LED's.” Continuing with the telecommunication field, under “DFB (Distributed Feedback Laser)” one may find the definition: “A type of laser used in fiber-optic transmission for light wave telecommunication systems. These are point to point lasers distributed among nodes in a geographic area. They have one strong mode or resonance (as opposed to multiple modes of a Fabry-Perot laser diode).”

Just below the icon line, there's a box with the commodity category, in the example of FIG. 4a: “Electrical Lab Equipment.” According to a feature of the inventive user interface, below the commodity category there is provided a section for “Notes.” These may include special notes and warnings that are important for proper classification and compliance with various import and other regulations. After the notes the classification active window prompts the user to reply to questions that require only technical knowledge of the imported part, rather than knowledge of import regulations. Also, in this example, the part number (e.g. UPC bar code) of the part to be classified is always shown next to the prompting question, in the arbitrary example of FIG. 4a: “SG000x5.” Finally, at the bottom of the screen, the user is provided with conventional “save” “edit” “finish” and “logout” functions.

To illustrate, the user is attempting to classify a signal generator intended as tab equipment. After the login step (not illustrated) the user enters the part number to classify and the countries of interest (not illustrated). The user is then given a menu of commodity categories, from which the user selected “Electrical Lab Equipment” (not illustrated). At this point, the screen shown in FIG. 4a appears, enabling the classification process using simplified questions that enable progress through the decision tree 130.

In FIG. 4a, the commodity category is shown to be “Electrical Lab Equipment,” and a note is provided to the user indicating that electrical lab equipment does not include laser sources, which are provided for under the Optical Equipment commodity category. In the prompt field, the item number is displayed and the user is asked: “Is the lab equipment a:” In this example, four possible answers are given. This is because for this example, using the knowledge of the importer business, the only electrical lab equipment from the HTSUS that needed to be mapped are “signal generators” “oscilloscopes” and “power suppliers.” The “other” is provided as a catch all bucket.

According to a feature of this example, the catch all bucket may follow a few branches in decision tree 130, however, if it appears that no proper solution is arrived at, the user is provided with a contact name and number for a specialized broker the company is working with. The user can then consult the expert and, when an appropriate classification is received from the broker, the user is given an opportunity to enter it manually.

In the example of FIG. 4a and 4b, the user clicks on “signal generator” in FIG. 4a, at which point the screen changes to that illustrated in FIG. 4b. Specifically, new notes specific to signal generators are provided, and a new question is provided with various possible selections. Now, if the user clicks on one of the possible answers, the appropriate classification number will be given by the system. Thus, as can be seen, the user is able to apply the proper HTSUS classification without any working knowledge of the HTSUS.

An option in this example is to blank the classification item number from all users, or from a group of users. For example, an import company may wish to limit access to its classification numbers only to a certain executive level in the company. Thus, although personnel below that level may perform classification of items, the final classification item number is not shown to such a user, but the system simply indicates that the proper classification has been selected (see, e.g., block 255 of FIG. 2). The user may then save and exit the program. However, if a personnel of appropriate executive level checks the item in the system, such a person will be able to see the actual tariff number.

### EXAMPLE 6

According to an “organization chart” feature of the invention, a conventional organization chart software is used to construct the decision tree. That is, as illustrated in FIG. 2, a readily available program, such as Power Point™ or Vision™, for example, is used in the “organization chart” mode in order to easily and inexpensively construct a decision tree. The tariff numbers that have been mapped onto the new field are entered into the program in an organizational chart mode, thereby providing visual mapping of the decision tree. This mapping can be used as a tool to construct the decision tree of the final classification program, and may also be provided as a visual tool accessible to the user of the classification program.

The invention has been described with reference to various embodiments and examples thereof. However, it should be understood that various modifications and implementation of the invention may be made without departing form the invention's spirit and scope.

I claim:

1. A method for assigning an item number to an item from a list of item numbers in a classification set, comprising:
creating a secondary classification set defining a new classification field;
mapping selected item numbers from the list of item numbers in said classification set onto said secondary classification set;
creating a decision tree for said selected item numbers; and
creating a questionnaire corresponding to said decision tree.

2. The method of claim 1, wherein said selected item numbers comprises a subset of said item numbers.

3. The method of claim 1, wherein said mapping selected item numbers comprises providing a transfer function, said transfer function enabling deciding, for each item number in said classification set, whether it should be included in said secondary classification set.

4. The method of claim 1, wherein each of said item numbers in said list of item numbers further includes an item description, and wherein said mapping selected item numbers further comprises, at least for some of the item numbers, changing said item description.

5. The method of claim 1, wherein said questionnaire is constructed in the form of a computer user interface.

6. The method of claim 1, wherein said classification set comprises one of the Harmonized Tariff System (HTS), the Harmonized Tariff Schedule of the United States (HTSUS), and a country specific HTS.

7. The method of claim 6, wherein said secondary classification set comprises a subset of said one of HTS, HTSUS, and country specific HTS.

8. The method of claim 5, wherein said user interface further comprises a display field for applicable regulations.

9. The method of claim 5, wherein said user interface further includes a keyword field for keyword search of said decision tree.

10. The method of claim 5, wherein said user interface comprises hypertext.

11. A method for assigning a tariff number from the Harmonized Tariff Schedule of the United States (“HTSUS”) to an item to be imported, comprising:
creating a secondary classification set;
mapping selected tariff numbers from the HTSUS onto said secondary classification set;
creating a decision tree for said selected item numbers; and
creating a questionnaire corresponding to said decision tree.

12. The method of claim 11, wherein said secondary classification set comprises a subset of said HTS.

13. The method of claim 11, wherein said questionnaire comprises questions requiring no knowledge of the HTS.

14. The method of claim 11, wherein said secondary classification set comprises blocks of classification items, each block corresponding to a different item class.

15. The method of claim 13, wherein said questionnaire is constructed in the form of a computer user interface comprising hypertext.

16. The method of claim 11, further comprising using a company's business information to construct a transfer function, and using said transfer function to perform said mapping selected tariff numbers.

17. The method of claim 16, wherein said secondary classification set comprises blocks of classification items, each block corresponding to different item class, and wherein said transfer function maps selected items from said HTS onto a selected one of said blocks of classification items.

18. The method of claim 11, wherein said decision tree is constructed in the form of an organization chart.

19. A computer program stored on a computer readable medium, comprising: at least one classification block, said classification block having
selected HTS tariff numbers mapped thereto from a country specific HTS;
a decision tree for said classification blocks;
a user interface enabling progression in said decision tree; wherein when operated, said computer program causes a computer to perform the functions comprising:
enabling a user of said computer to assign an HTS tariff number to an import item by performing the functions comprising:
asking the user to respond to questions relating to the characteristics of the imported item in order to progress through the decision tree and to arrive at an appropriate tariff number.

20. The computer program of said claim 18, wherein said classification blocks are expandable.

21. The computer program of claim 19, wherein the tariff numbers mapped onto said classification blocks comprise a subset of said country specific HTS tariff numbers.
